(19) United States
(12) Patent Application Publication
(10) Pub. No.: US 2026/0253463 A1
(43) Pub. Date: Aug. 27, 2026

(54) METHOD FOR ESTIMATING A DRY FRICTION DEVIATION VALUE

(71) Applicant: JTEKT EUROPE, Irigny (FR)

(72) Inventor: Quentin FRAISON, Irigny (FR)

(73) Assignee: JTEKT EUROPE, Irigny (FR)

(21) Appl. No.: 19/544,230

(22) Filed: Feb. 19, 2026

(30) Foreign Application Priority Data
Feb. 21, 2025 (FR) 2501801

(51) Int. Cl. G07C 5/08

(52) U.S. Cl. CPC G07C 5/0808

(57) ABSTRACT

A method for estimating a dry friction deviation value representative of a deviation between an actual value of dry friction exerted on a power steering system of a vehicle and a nominal dry friction value, the method comprising the following steps implemented by data processing means: a) determining a value of force exerted on a rack of the power steering system, b) determining the nominal dry friction value based on the speed of the vehicle, c) calculating the dry friction deviation value based on the force value and the nominal dry friction value, assuming that the dry friction deviation value is independent of the speed of the vehicle.

### FIELD OF THE INVENTION

The present invention relates to the field of power steering of a vehicle, more specifically the estimation of values relating to friction on a power steering system and, more particularly, a method for estimating a dry friction deviation value representative of a deviation between an actual value of dry friction exerted on a power steering system of a vehicle and a nominal dry friction value.

### PRIOR ART

Electric power steering systems, called “EPS”, use an electric motor to assist the driver in steering their vehicle.

The primary objective of the electric power steering is assistance, that is to say, reducing the steering wheel/driver torque during a given movement. Thus, a steering wheel/driver torque sensor is configured to measure the torque exerted by the driver on the vehicle's steering column, and a calculator determines the associated assistance and controls the electric motor of the electric power steering based on the measured torque and driving conditions to provide an additional torque to the pinion of the rack connected on one side to the steering wheel via the steering column and on the other side to the wheels via steering tie rods.

The second objective of the electric power steering is to provide the driver with good steer feel.

The drawback of the early “assistance laws”, which are based solely on the steering wheel/driver torque, is that the driver feels a significant amount of mechanical friction of the steering, which is considered to be imprecise. Indeed, for small movements, especially near zero, when the steering wheel/driver torque is very low (for example, when the steering wheel is released), if there is movement in one direction, the assistance stops and the driver experiences a sticking feeling due to friction of the steering, meaning that the mechanical friction of the electric power steering reduces or even cancels the rack movements under low driver force input, which degrades driving precision by imposing large and non-linear variations in steering wheel/driver torque to achieve fine movement corrections. Hysteresis is then observed: meaning that the steering wheel/driver torque in one direction differs from the steering wheel/driver torque in the other direction. To improve the feeling, this hysteresis must be reduced by continuously compensating for the mechanical friction of the steering, including under low driver input and therefore at very low displacement speeds.

Patents No. FR3073638 and No. FR3070957 describe a solution for estimating friction in order to compensate for it.

However, this solution has several drawbacks. In particular, friction remains difficult to estimate when the vehicle speed varies. Indeed, since friction varies with the vehicle speed, the calculator requires a considerable amount of time, at a given speed, to estimate friction and, consequently, determine the corresponding assistance. As a result, the assist motor does not deliver enough torque to compensate for friction on the steering system. The driver's feel is therefore not optimal. Moreover, in patent No. FR3070957, the estimation can only be performed during vehicle steering operations.

There is therefore a need for a more efficient and reliable solution making it possible to estimate friction, in particular dry friction, on a power steering system of a vehicle in order to compensate for this friction.

### DISCLOSURE OF THE INVENTION

One aim of the invention is to compensate for dry friction exerted on a power steering system of a vehicle in a reliable, efficient and rapid manner.

To this end, one aim of the invention is to estimate, in a reliable, efficient and rapid manner, a dry friction deviation value representative of a deviation between an estimated actual value of dry friction exerted on a power steering system of a vehicle and a nominal dry friction value.

According to a first aspect, a method for estimating a dry friction deviation value representative of a deviation between an actual value of dry friction exerted on a power steering system of a vehicle and a nominal dry friction value is proposed, the method comprising the following steps implemented by data processing means:
a) determining a value of force exerted on a rack of the power steering system,
b) determining the nominal dry friction value based on the vehicle speed,
c) calculating the dry friction deviation value based on the force value and the nominal dry friction value, assuming that the dry friction deviation value is independent of the vehicle speed.

Depending on advantageous and non-limiting features, taken alone or in any combination:
step c) of calculating the dry friction deviation value comprises calculating a difference operation between the force value and the nominal dry friction value;
in step c), the calculation of the dry friction deviation value is further implemented based on a value of viscous friction exerted on the power steering system;
in step c), the calculation of the dry friction deviation value is further implemented based on a lateral acceleration value of the vehicle preferably weighted by a gain;
the gain depends on a nominal gain value determined based on the vehicle speed and a gain deviation value assumed to be independent of the vehicle speed;
in step c), the calculation of the dry friction deviation value is implemented by solving the following equation:

$$α * {γ}_{lat} + β = Force - {K}_{nominal} * {γ}_{lat} - f d r {y}_{nominal} - fviscous$$

with β corresponding to the dry friction deviation value,
Force corresponding to the force value,
Kₙₒₘᵢₙₐₗ corresponding to the nominal gain value,
α corresponding to the gain deviation value independent of the vehicle speed,
γₗₐₜ corresponding to the lateral acceleration value of the vehicle,
fdryₙₒₘᵢₙₐₗ corresponding to the nominal dry friction value, and
fviscous corresponding to the value of viscous friction;
the force value depends on a value of a force from an assist motor on the rack and/or a value of a force from a steering wheel on the rack;
in step b), the nominal dry friction value is determined from a predetermined nominal dry friction model;
the nominal dry friction value is determined based on at least one other parameter among an angle of the steering wheel, a temperature of the power steering system, and a road type.

According to a second aspect, a method for compensating for dry friction exerted on a power steering system of a vehicle is proposed, comprising the following steps:
estimating a dry friction deviation value representative of a deviation between an actual value of dry friction exerted on a power steering system of a vehicle and a nominal dry friction value by implementing the method for estimating a dry friction deviation value as previously presented,
correcting a value of a force to be applied by an assist motor to the rack based on the dry friction deviation value so as to compensate for dry friction exerted on the power steering system.

According to a third aspect, a power steering system for a vehicle comprising an electronic control unit configured to implement the estimation method as previously presented or the compensation method as previously presented, is proposed.

According to a fourth aspect, a computer program product comprising code instructions for the execution of the estimation method as previously presented or of a compensation method as previously presented, when said program is executed on a computer, is proposed.

According to a fifth aspect, a storage means readable by computer equipment on which a computer program product comprises code instructions for the execution of the estimation method as previously presented or of a compensation method as previously presented.

### DESCRIPTION OF THE FIGURES

Other features and advantages of the present invention will become apparent upon reading the following description of a preferred embodiment. This description will be given with reference to the accompanying figures, including:

FIG. 1 schematically represents a power steering system of a vehicle;

FIG. 2 represents the steps of a method for estimating the deviation value;

FIG. 3 represents the steps of a method for compensating for dry friction.

### DETAILED DESCRIPTION OF THE INVENTION

### System

A power steering system 1 for a vehicle 2, and more particularly for a motor vehicle 2 intended for transporting people is proposed.

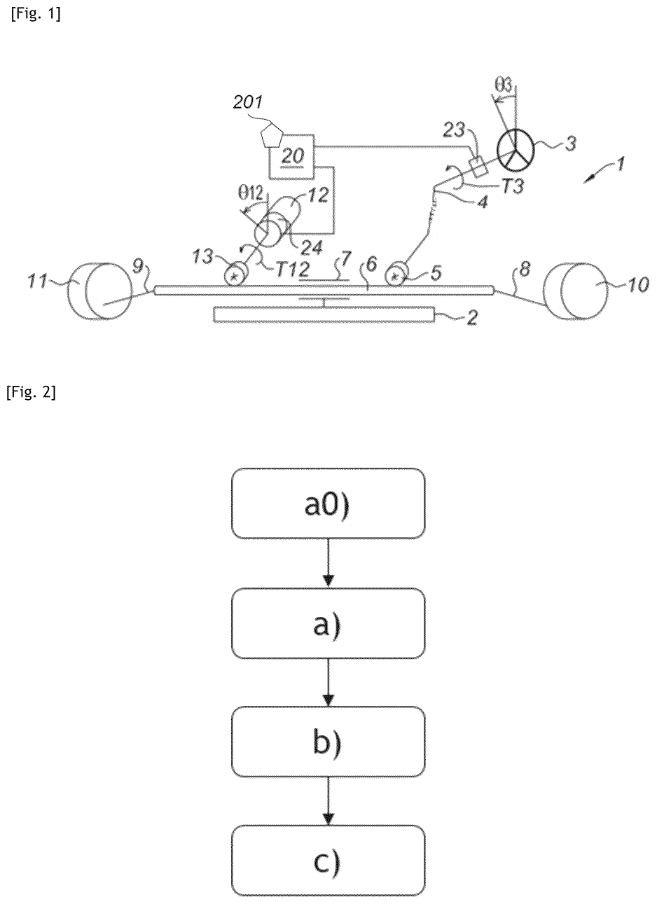

In a manner known per se, and as shown in FIG. 1, the power steering system 1 comprises a steering wheel 3 which allows a driver to maneuver the power steering system 1 by exerting a force, called “steering wheel torque” T3, on the steering wheel 3. An angle θ3 of the steering wheel 3 is measured by an angle sensor 23. The steering wheel torque T3 and the angle θ3 of the steering wheel are transmitted to an electronic control unit 20.

The steering wheel 3 is preferably mounted on a steering column 4, guided in rotation on the vehicle 2, and which meshes, by means of a steering pinion 5, with a steering rack 6, which is itself guided in translation in a steering casing 7 fastened to the vehicle 2.

Preferably, the ends of said steering rack 6 are each connected to a steering tie rod 8, 9 connected to the steering knuckle of a steered wheel 10, 11 (respectively a left wheel 10 and a right wheel 11), so that the translational longitudinal displacement of the rack 6 makes it possible to modify the steering angle (yaw angle) of the steered wheels.

Moreover, the steered wheels 10, 11 can also preferably be drive wheels.

The power steering system 1 also comprises an assist motor 12 intended to provide an assist motor force T12, and more particularly an assist motor torque T12, to assist the maneuver of the power steering system 1.

The assist motor 12 will preferably be an electric motor, with two directions of operation, and preferably a rotary electric motor, of the brushless or brushed type.

The assist motor 12 can engage, if necessary via a reducer of the gear reducer type, either on the steering column 4 itself, to form a so-called “single pinion” mechanism, or directly on the steering rack 6, for example by means of a second pinion 13 distinct from the steering pinion 5 which allows the steering column 4 to mesh with the rack 6, so as to form a so-called “double pinion” mechanism, as illustrated in FIG. 1, or else by means of a ball screw which cooperates with a corresponding thread of said rack 6, at a distance from said steering pinion 5.

A mechanical type electric power steering system 1 has been described here, that is to say, one in which there is a mechanical link between the steering wheel and the rack.

However, the invention can equally be applied to an electric power steering system without mechanical link, not shown, called “steer-by-wire”, in which the steering wheel is mechanically detached from the rack. In this case, the steering system comprises a steering wheel unit that is mechanically independent of a rack unit.

In the steering wheel unit, a control regulator controls the control motor in such a way as to particularly make the driver aware of the inertia of the rack, that is to say, a weight of the rack.

In the rack unit, an assistance regulator controls an assist motor that exerts an assist motor torque on the rack. More specifically, the steering wheel angle is measured or calculated so as to determine a setpoint angle to be reached by an angular position of the rack. The assistance regulator servo-controls an angular position of the maneuvering motor to the setpoint angle by controlling a motor torque exerted by the assist motor on the rack. The angular position of the assist motor corresponds to the angular position of the rack modified by a value of a mechanical stiffness between the assist motor and the rack, and by a virtual stiffness programmed into the assistance regulator and representing a stiffness between the assist motor and the steering wheel.

The invention is not limited to a particular type of power steering system.

The power steering system 1 comprises an electronic control unit (ECU) 20 comprising data processing means 201, such as a processor, and configured to control the assist motor 12.

The data processing means 201 are configured to implement a method for estimating a dry friction deviation value representative of a deviation between an actual value of dry friction exerted on the power steering system 1 of the vehicle 2 and a nominal dry friction value. This method will be detailed later.

The actual value of dry friction is also named actual dry friction value in the following.

This deviation value can allow estimating dry friction exerted on the system 1. This deviation value can allow dry friction to be taken into account by the assist motor.

To rephrase, the idea of the invention is not to directly attempt to determine the actual dry friction value, which is very complex, but simply to estimate a “deviation” value relative to a “nominal” dry friction value, which is a theoretical approximation, this deviation value being in practice much more easily estimated thanks to the present method.

Advantageously, the data processing means 201 of the electronic control unit 20 are configured to, based on the deviation value, correct the value of the force to be applied by the assist motor 12 to the rack 6. The electronic control unit 20 thus controls the assist motor 12 according to the corrected assist motor force value so as to reliably compensate for the dry friction exerted on the power steering system 1.

### Method

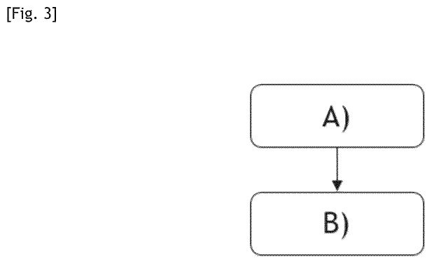

With reference to FIG. 2, a method for estimating a dry friction deviation value representative of a deviation between an actual value of dry friction exerted on a power steering system 1 of a vehicle 2 and a nominal dry friction value. The method is advantageously implemented when the vehicle 2 is traveling at a certain speed.

By speed, it should be understood the longitudinal speed of the vehicle 2, that is to say the speed in the direction of displacement of the vehicle 2.

A distinction is made between dry friction and viscous friction. Dry friction is independent of the speed of displacement of the rack-and-pinion mechanism of the steering system. Dry friction results from surface contact (lubricated or not) between two solids, in particular the pinion and the rack. Viscous friction is dependent on (and even proportional to) the speed of displacement of the mechanism.

Dry friction is highly dependent on the vehicle speed, making its compensation difficult. The invention aims to provide a solution to this problem.

The method advantageously comprises a preliminary step a0) of determining a predetermined nominal dry friction model. The model aims to enable the determination, based on the speed of the vehicle 2, of a nominal dry friction value.

A nominal dry friction value is an expected dry friction value when the vehicle 2 is moving at a certain speed. In other words, when the vehicle 2 is moving at a certain speed, a certain dry friction value that is equal to the nominal dry friction value is expected.

It is reiterated that said nominal dry friction value is a theoretical value, so that in practice the actual dry friction value is considered to be close to, but not equal to, the nominal dry friction value, and that the actual dry friction value has said deviation value from the nominal dry friction value. By actual dry friction value, it should be understood a dry friction value that is considered representative of the dry friction exerted on the system 1 in reality. This actual dry friction value is not known at the beginning of the method and is assumed to be expressed based on the nominal dry friction value and the dry friction deviation value. The method aims precisely to calculate the dry friction deviation value, thus allowing the actual dry friction value to be characterized, or even calculated.

The nominal dry friction value, as explained, is dependent on the vehicle speed, while the present method estimates the deviation value by assuming it to be independent, i.e., not dependent on the vehicle speed. In other words, the actual dry friction value is expressed based on a component dependent on the vehicle speed, namely the nominal dry friction value, and a component that has been decided to be independent of the vehicle speed, namely the dry friction deviation value. Thus, the actual dry friction value has been cleverly decomposed into a component dependent on the vehicle speed and a component independent of the vehicle speed, which allows, as will be detailed later, for reliable compensation of dry friction at any vehicle speed, even when the speed varies.

Modeling this deviation as a quantity independent of the speed greatly facilitates its calculation while paradoxically maintaining a high quality of estimation.

As explained, the nominal dry friction value can be determined using a model, and this model is advantageously determined in step a0).

Step a0) consists in constructing the model which makes it possible, based on the speed of a vehicle, to determine the nominal dry friction value.

The model can be any mathematical model such as a function or an abacus.

The model is advantageously constructed empirically, by driving a vehicle and performing, at different speeds of displacement of the vehicle, dry friction measurements.

Dry friction measurements can be taken, for example, by performing maneuvers on a flat track with a reference vehicle and a reference power steering system. The maneuvers are, for example, sinusoidal (alternating right-left steering, with the steering wheel angle following a sinusoidal time evolution) at a maximum lateral acceleration of 0.1 g, a very low steering wheel speed (<10 deg/s), and a constant vehicle speed. Measurements are preferably taken at different speeds, for example, 20 km/h, 40 km/h, 60 km/h, etc. After measurement, in a rack force vs. lateral acceleration plane, the curve can be summarized as two parallel straight lines forming a hysteresis. The half-hysteresis corresponds globally to friction (dry and viscous). Since the steering wheel speed is very low, it is considered that the half-hysteresis corresponds to dry friction. The slope of the straight lines preferably corresponds to a nominal gain value, which will be detailed later. The choice of the “rack force” versus “lateral acceleration” plane advantageously replaces a “rack force” versus angle plane, as the slope of the straight lines varies less in the chosen plane. In any case, a person skilled in the art knows how to perform such measurements to construct the model.

Advantageously, the model makes it possible to determine the nominal dry friction value based on the speed of the vehicle 2 and other parameters relating to the vehicle, its displacement, and/or its environment. For example, the parameters comprise at least one among: an angle of the steering wheel, a temperature of the power steering system, a road type, and an indication of the power steering system wear.

Thus, preferably, step a0) consists in constructing the model based on the speed of a vehicle and other parameters relating to the vehicle, its displacement, and/or its environment. In other words, dry friction measurements are taken under different circumstances.

Advantageously, the model is associated with a vehicle type and/or model so that the model is specifically adapted to the vehicle's operation. Thus, step a0) can be implemented for a plurality of reference vehicles so as to obtain a model for each vehicle type/model in said plurality of reference vehicles.

Step a0) is advantageously implemented only once, on a reference vehicle designed for this purpose, and the model can then be implemented in the data processing means 201 of any suitable vehicle. Thus, step a0) is preferably implemented by means of data processing means, but these data processing means are in practice different from the data processing means 201 by means of which the rest of the method (i.e., steps a), b), and c)) is implemented. Therefore, step a0) is not implemented each time the method is implemented.

The method comprises a step a) of determining a value of force exerted on the rack 6 of the power steering system 1.

Advantageously, the force value depends on a value of a force from the assist motor 12 on the rack 6 and/or a value of a force from the steering wheel 3 on the rack 6.

In some cases, the force value depends solely on the value of a force from the assist motor 12 on the rack 6, for example, in the case of a power steering system without mechanical link or in the case of an autonomous vehicle. Alternatively, in these cases, the force value may depend on the value of a force from the assist motor 12 on the rack 6 and the value of a force from the steering wheel 3 on the rack 6, but the value of a force from the steering wheel 3 is considered to be zero.

Preferably, the value of a force from the assist motor 12 on the rack 6 is a torque, called assist motor torque.

Preferably, the value of a force from the steering wheel 3 on the rack 6 is a torque called steering wheel torque.

Advantageously, the force value is named the Rack Force estimation (RFe) which is the sum of the forces exerted by the steering wheel and by the assist motor on the rack.

Thus, preferably, the force value corresponds to the sum of a value of a force from the assist motor 12 on the rack 6 and the value of a force from the steering wheel 3 on the rack 6.

The method comprises a step b) of determining the nominal dry friction value based on the speed of the vehicle 2.

The nominal dry friction value is advantageously determined by means of the predetermined nominal dry friction model, from the speed of the vehicle 2.

Preferably, the nominal dry friction value is further determined based on at least one parameter relating to the vehicle, its displacement, and/or its environment. The at least one parameter advantageously comprises an angle of the steering wheel, a temperature of the power steering system, and/or a road type.

Thus, at the end of step b), the data processing means 201 determined the nominal dry friction value, which is the dry friction value that had been measured on a reference vehicle during the construction of the model, for the same speed and possibly for the same parameters relating to the vehicle, its displacement and/or its environment.

The data processing means 201 have therefore determined, as previously explained, the component of the actual dry friction value that depends on the vehicle speed.

The method then comprises a step c) of calculating the dry friction deviation value based on the force value and the nominal dry friction value, assuming that the dry friction deviation value is independent of the vehicle speed.

In other words, it was based on the assumption that the deviation value does not depend on the vehicle speed. In other words, a variation in the vehicle speed does not cause the deviation value to vary. The component of the actual dry friction value that depends on the vehicle speed, which is therefore the nominal dry friction value, is already determined and was quickly determined using the predetermined model. In the prior art, it is complicated and time-consuming, and therefore impossible, to efficiently estimate a reliable dry friction value due to speed variations. Indeed, in the prior art, measurements must be acquired at numerous moments (several hundred measurement points to be acquired) to be able to determine friction, which is very time-consuming. The present invention makes it possible to take speed variations into account and to efficiently estimate a reliable actual dry friction value by separately determining a component of the actual dry friction value that depends on the vehicle speed and a component that does not depend on the vehicle speed.

More specifically, assuming that the dry friction deviation value is independent of the vehicle speed means, for example, that when calculating the dry friction deviation value, a mathematical hypothesis is that this dry friction deviation value does not vary with the vehicle speed.

Advantageously, step c) of calculating the dry friction deviation value comprises calculating a difference operation between the force value and the nominal dry friction value.

Preferably, in step c), the calculation of the dry friction deviation value is further implemented based on a value of viscous friction exerted on the power steering system. Thus, viscous friction is also taken into account to determine the dry friction deviation value, which is therefore more reliable because it is closer to reality.

The value of viscous friction is also named viscous friction value.

In one embodiment, the viscous friction value is determined using a model making it possible to determine a viscous friction value based on various parameters, in particular the vehicle speed. Advantageously, the model is constructed similarly to that making it possible to determine a dry friction value, but preferably at a steering wheel speed greater than 10 deg/s. For the construction of the model, the viscous friction measurements can be determined by varying the steering wheel speed. For example, it is considered that, at a steering wheel speed higher than 10 deg/s (for example 30 deg/s), the deviation between an overall friction measurement (i.e., dry and viscous) and a dry friction measurement corresponds to viscous friction. Viscous friction is considered proportional to the steering wheel speed. A person skilled in the art will, in any case, be able to perform such measurements to construct the model.

Advantageously, in step c), the calculation of the dry friction deviation value is further implemented based on a lateral acceleration value of the vehicle, which is preferably weighted by a gain. The lateral acceleration is the force acting on a vehicle when it turns or changes direction. The gain, multiplied by the lateral acceleration, makes it possible to express an equivalent lateral acceleration that varies less with the vehicle speed. Thus, the dry friction deviation value is more reliable as it is closer to reality.

A person skilled in the art can calculate the lateral acceleration, for example, based on the vehicle speed, the steering wheel angle, and a specific gain that depends primarily on the vehicle's geometry. This specific gain is different and should not be confused with the gain mentioned throughout the rest of the description.

More preferably, the gain depends on a nominal gain value determined based on the vehicle speed and a gain deviation value assumed to be independent of the vehicle speed. This gain and this gain value are different from the specific gain mentioned in the preceding paragraph. Advantageously, the nominal gain value is determined from a model, using the vehicle speed, said model being able to be constructed in the same way as the model constructed in step a0). One way to obtain the nominal gain value is detailed in the description of step a0). This decomposition of the gain also makes it possible to express the dry friction deviation value in a way that is even closer to reality, thus obtaining an accurate and reliable value that will allow for accurate friction compensation.

Advantageously, in step c), the calculation of the dry friction deviation value is implemented by solving the following equation:

$$α * {γ}_{lat} + β = Force - {K}_{nominal} * {γ}_{lat} - f d r {y}_{nominal} - fviscous$$

with β corresponding to the dry friction deviation value,
Force corresponding to the force value,
Kₙₒₘᵢₙₐₗ corresponding to the nominal gain value,
α corresponding to the gain deviation value independent of the vehicle speed,
γₗₐₜ corresponding to the lateral acceleration value of the vehicle,
fdryₙₒₘᵢₙₐₗ corresponding to the nominal dry friction value, and
fviscous corresponding to the viscous friction value.

The dry friction deviation value β can thus be determined by solving this equation. Note that the equation comprises, on the left, terms independent of the vehicle speed (α and β) and, on the right, only terms dependent on the vehicle speed. This decomposition allows the system to be expressed in a way that is close to reality.

In this equation, the values α and β are unknowns. The other values are determined, based on speed, for example using models.

The resolution makes it possible to determine the values α and β, in particular β.

Assuming that the dry friction deviation value is independent of the vehicle speed means that, when seeking to solve this equation, a constraint that is applied (and for example imposed on data processing means responsible for solving the equation) is that the dry friction deviation value β does not vary with the vehicle speed.

The dry friction deviation value (β) obtained thanks to the present invention is obtained simply and quickly and is a simple value which thus enables better performance of algorithms which would take this value as input.

The dry friction deviation value (β) can advantageously be taken as input to a dry friction compensation algorithm of the electronic control unit 20. For example, this algorithm knows the nominal dry friction value and also takes as input the dry friction deviation value and can, from these values, determine how to correct the assistance force that the assist motor 12 must apply to the rack 6 to compensate for dry friction and thus provide the driver with a high-quality steer feel. The present invention makes it possible to compensate for dry friction very quickly (the system can adapt in less than 2 km of driving), whereas, in the prior art, it might be necessary to wait for several hundred kilometers of driving (consecutively) for the electronic control unit to adapt to friction, which effectively made friction compensation impossible if the speed changes. Thus, thanks to the dry friction deviation value of the invention, the compensation algorithms are more efficient.

Alternatively, the data processing means 201 can be configured to estimate the actual dry friction value from the dry friction deviation value and the nominal dry friction value. For example, the actual dry friction value can be calculated by summing the dry friction deviation value and the nominal dry friction value. This estimation of the actual dry friction value can be taken as input by the compensation algorithm, which can then correct the assistance force that the assist motor 12 must apply to the rack 6.

Thus, advantageously, with reference to FIG. 3, a method for compensating dry friction exerted on the power steering system 1 is proposed. The compensation method is advantageously implemented by the electronic control unit 20. The compensation method comprises a step A) of estimating a dry friction deviation value representative of a deviation between an actual value of dry friction exerted on the power steering system 1 and a nominal dry friction value, by implementing the estimation method as previously presented. Then, the compensation method comprises a step B) of correcting a value of a force to be applied by the assist motor 12 to the rack 6 based on the dry friction deviation value so as to compensate for dry friction exerted on the power steering system 1.

### COMPUTER PROGRAM PRODUCT AND READABLE STORAGE MEANS

Also proposed is a computer program product comprising code instructions for the execution of the method for estimating a dry friction deviation value representative of a deviation between an actual value of dry friction exerted on a power steering system 1 of a vehicle 2 and a nominal dry friction value, when said program is executed on a computer.

Also proposed is a storage means readable by computer equipment on which a computer program product comprises code instructions for the execution of the method for estimating a dry friction deviation value representative of a deviation between an actual value of dry friction exerted on a power steering system of a vehicle and a nominal dry friction value.

1. A method for estimating a dry friction deviation value representative of a deviation between an actual value of dry friction exerted on a power steering system of a vehicle and a nominal dry friction value, the method comprising the following steps implemented by data processing means:
a) determining a value of force exerted on a rack of the power steering system,
b) determining the nominal dry friction value based on the speed of the vehicle,
c) calculating the dry friction deviation value based on the force value and the nominal dry friction value, assuming that the dry friction deviation value is independent of the speed of the vehicle.

2. The method according to claim 1, wherein step c) of calculating the dry friction deviation value comprises calculating a difference operation between the force value and the nominal dry friction value.

3. The method according to claim 1, wherein, in step c), the calculation of the dry friction deviation value is further implemented based on a value of viscous friction exerted on the power steering system.

4. The method according to claim 1, wherein, in step c), the calculation of the dry friction deviation value is further implemented based on a lateral acceleration value of the vehicle weighted by a gain.

5. The method according to claim 4, wherein the gain depends on a nominal gain value determined based on the speed of the vehicle and a gain deviation value assumed to be independent of the speed of the vehicle.

6. The method according to claim 1, wherein, in step c), the calculation of the dry friction deviation value is implemented by solving the following equation:
$$α * {γ}_{lat} + β = Force - {K}_{nominal} * {γ}_{lat} - f d r {y}_{nominal} - fviscous$$
with β corresponding to the dry friction deviation value,
Force corresponding to the force value,
Kₙₒₘᵢₙₐₗ corresponding to the nominal gain value,
α corresponding to the gain deviation value independent of the speed of the vehicle,
γₗₐₜ corresponding to the lateral acceleration value of the vehicle,
fdryₙₒₘᵢₙₐₗ corresponding to the nominal dry friction value, and
fviscous corresponding to the value of viscous friction.

7. The method according to claim 1, wherein the force value depends on a value of a force from an assist motor on the rack and on a value of a force from a steering wheel on the rack.

8. The method according to claim 1, wherein, in step b), the nominal dry friction value is determined from a predetermined nominal dry friction model.

9. The method according to claim 8, wherein the nominal dry friction value is determined based on at least one other parameter among an angle of the steering wheel, a temperature of the power steering system, and a road type

10. A method for compensating for dry friction exerted on a power steering system of a vehicle comprising the following steps:
estimating a dry friction deviation value representative of a deviation between an actual value of dry friction exerted on a power steering system of a vehicle and a nominal dry friction value by implementing the method according to claim 1,
correcting a value of a force to be applied by an assist motor to the rack based on the dry friction deviation value so as to compensate for dry friction exerted on the power steering system.

11. A power steering system for a vehicle comprising an electronic control unit configured to implement the estimation method according to claim 1.

12. A computer program product comprising code instructions for the execution of a method according to claim 1 for estimating a dry friction deviation value representative of a deviation between an actual value of dry friction exerted on a power steering system of a vehicle and a nominal dry friction value or of a method for compensating for dry friction exerted on a power steering system of a vehicle.

13. A storage means readable by computer equipment on which a computer program product comprises code instructions for the execution of a method according to claim 1 for estimating a dry friction deviation value representative of a deviation between an actual value of dry friction exerted on a power steering system of a vehicle and a nominal dry friction value or of a method for compensating for dry friction exerted on a power steering system of a vehicle.
